(19) United States
(12) Patent Application Publication
(10) Pub. No.: US 2025/0114765 A1
(43) Pub. Date: Apr. 10, 2025

(54) Synthetic Particle Confinement Synthesis And Uses Thereof

(71) Applicant: West Nanorobotics LLC, Pendleton, IN (US)

(72) Inventor: Tory C Weston, Pendleton, IN (US)

(73) Assignee: West Nanorobotics LLC, Pendleton, IN (US)

(21) Appl. No.: 18/482,886

(22) Filed: Oct. 8, 2023

(51) Int. Cl. B01J 19/08

(52) U.S. Cl. CPC B01J 19/087; B01J 2219/085

(57) ABSTRACT

This is the synthesis for artificial quantum substrate particles using the confinement of magnetic fields in a torus shaped chamber upon a quark gluon plasma of the quarks constituents of the quantum substrate particle. There are several types of multi-quark particles that are able to be constructed by this synthesis being the “Red Matter” Quantum Substrate and Neutronium Quantum Substrate.

### BRIEF SUMMARY

The usage of a torus confinement device with superconducting magnets allows of the synthesis of Quantum Substrates under strong magnetic fields being supplemental to the force of the strong nuclear force compressing the quark gluon plasma of the constituent quarks into a quantum substrate. A quark gluon plasma of the constituent quarks must be placed within the magnetic field which will confine the quarks into a quantum substrate particle. There are two types of Quantum Substrates that could be synthesized along with many others however the ones that I devised are the “Red Matter” Quantum Substrates and Neutronium Quantum Substrates which are made by this method, if the particles created leave confinement the particles will destabilize into energy via Einstein's famous equation E=MC\hat{ }2 transforming their mass into energy due to being unstable when outside the confinement of the magnetic field torus confinement chamber due to the strong nuclear force being too weak to confine the particles on its own.

### BRIEF DESCRIPTION OF THE FIGURES

FIG. 1, This is a diagram of the Torus Magnetic Confinement Chamber

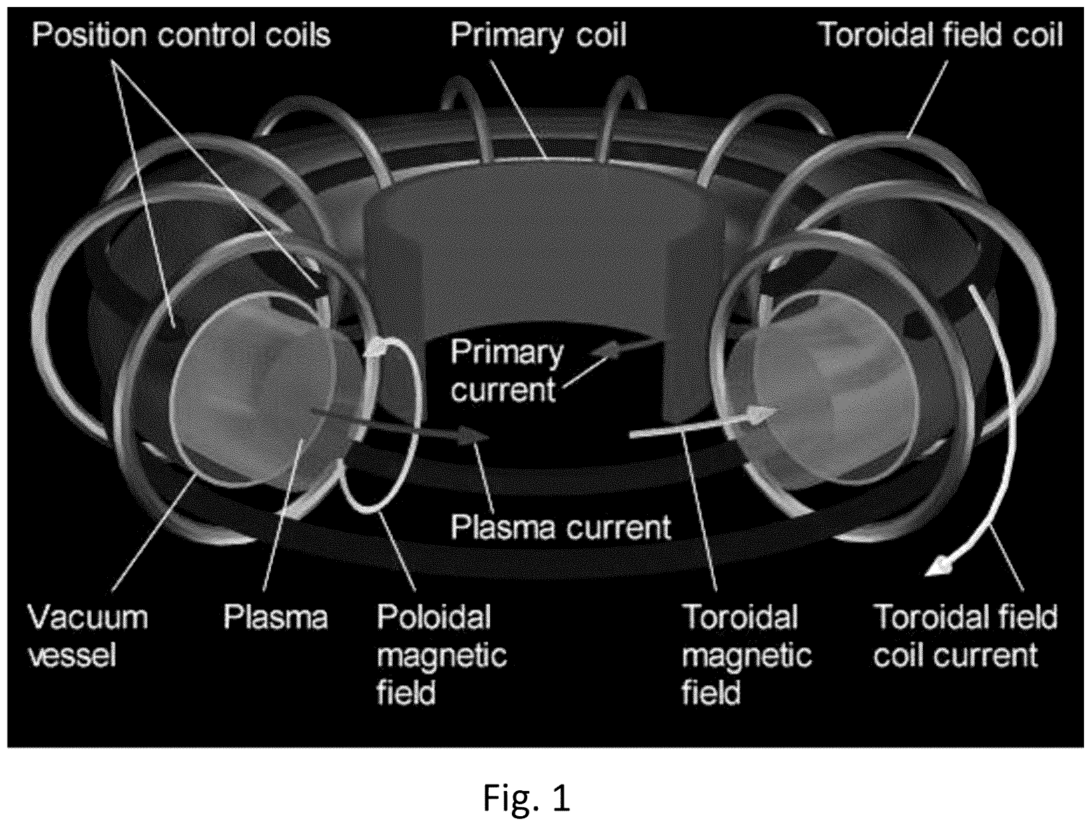

FIG. 2, This is a diagram of Neutronium Quantum Substrates

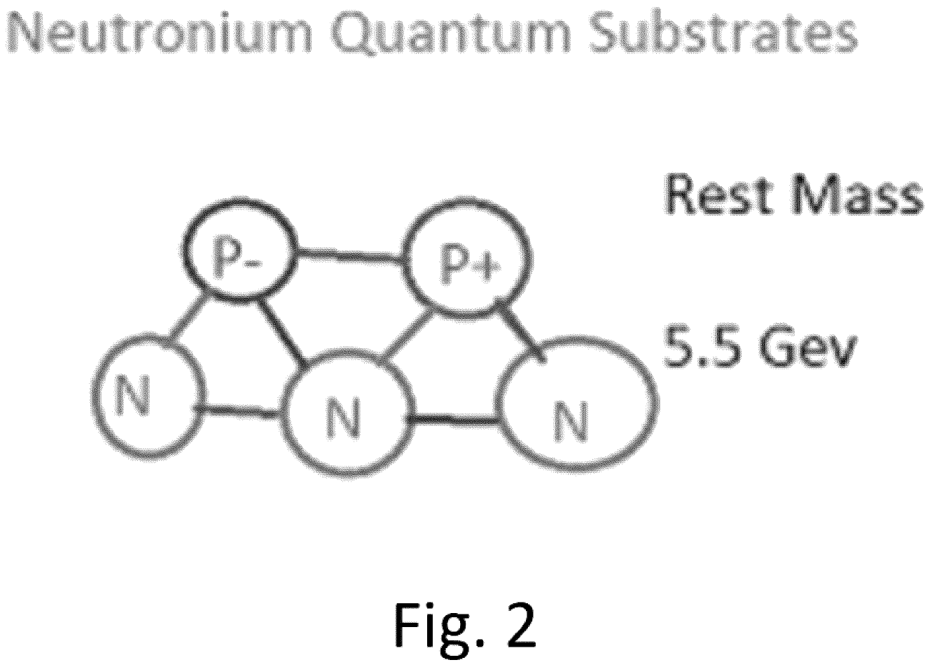

FIG. 3, This is a diagram of “Red Matter” Quantum Substrates and the magnetic confinement process

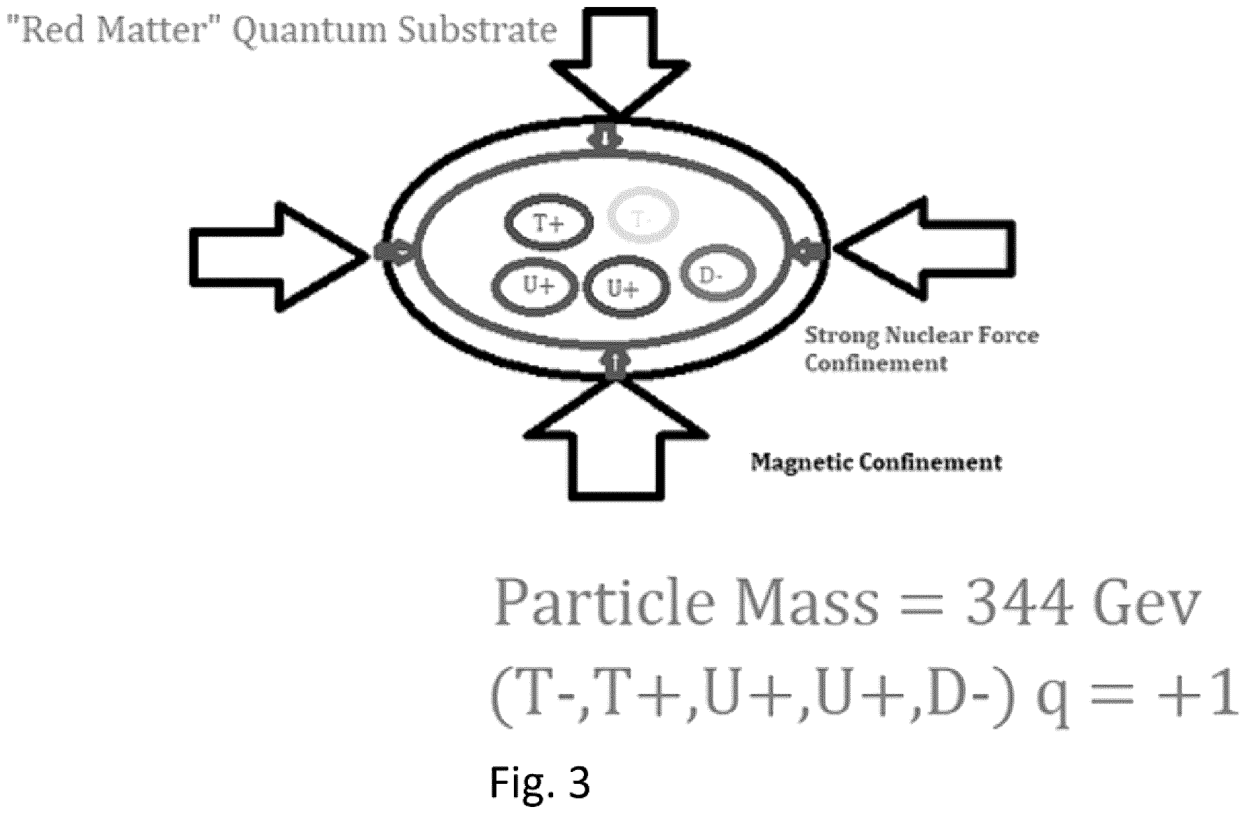

### DETAILED DESCRIPTION

The parts of the magnetic confinement torus are much like a hydrogen fusion reactor being a tokomak which has been known about since the early 60s the design concepts are much the same. The magnetic field confines the plasma however in this case it is a sort of “quantum fusion” that is taking place where the quarks or hadrons “fuse” into a quantum substrate by confinement by a magnetic field giving a extra binding reinforcing the strong nuclear force. The energy densities of quantum substrate binding is much higher than hydrogen fusion being for the “Red Matter” Quantum Substrate of 1.1824598130*10=J/m\hat{ }3, however it is achievable in a 30 Tesla per meter magnetic field at a velocity of the quark gluon plasma of 21,417.43 meters per second using superconductors such as cuprates or iron based superconductors. As for the Neutronium Quantum Substrate it has a energy density close to a helium 5 isotope being a somewhat similar the only difference being a proton traded for a anti-proton making the quantum substrate neutral instead of +2 charged for helium 5 which can be confined into a particle by the same method being synthetic particle confinement synthesis.

The magnetic confinement chamber or “tokomak” has a set of superconducting coils going around the torodial chamber confining the quark gluon plasma of constituent quarks which the current running through the superconductor is the source of the magnetic field with a solenoid magnet in the middle of the donut shape that the chamber makes. The strength of the magnetic field only needs to be 30 Tesla thus cuprates and iron based superconductors can sustain this amount of field strength without going through the dreaded quench where the superconductor loses superconductivity due to high magnetic field strength or high current. The actual size of the chamber would be the size of any other fusion reactor even existing fusion reactors could be used for this process given some adjustments such as a particle accelerator feeding into the reaction chamber with the constituent quark gluon plasma for the specific particle you wanted to make such as “Red Matter” Quantum Substrates or Neutronium Quantum Substrates. The chamber and magnetic field being used to magnetically confine the quark gluon plasma into the quantum substrate much like confining deuterium and tritium plasma in hydrogen fusion however the energy densities are higher especially for the “Red Matter” Quantum substrates.

The exact synthesis by synthetic particle confinement synthesis for “Red Matter” Quantum Substrates is pretty simple being collide particles together such as two protons at high energies in the Tev range such as those produced by a super collider making the constituent particles such as Top quarks, anti-top quarks, up, and down quarks for “Red Matter” Quantum substrates. Next, this needs to be turned into a plasma by laser heating and accelerated to near the speed of light to prevent decay of the quarks. Afterward, the constituent quarks need to enter the torodial chamber at near the speed of light to be confined by the magnetic field into the quantum substrate before the quarks decay. Once in the presence of the magnetic field compressing the quarks the quantum substrates will form at the proper energy density of 1.1824598130*10\hat{ }32 J/m\hat{ }3 which will form a 344 Gev rest mass “Red Matter” Quantum substrate particle in it's rest quantum state of n=1 under those pressures of the magnetic confinement. The exact energy requirements for the quantum substrate can be obtained from the particle in a box equation by using the size of a proton measurements as a L value, the rest mass of the quantum substrate as a m value, and a quantum state at rest as a n value retrieving the Eₙ value requirements to bind the quantum substrate particle which yields a Eₙ value of 1.02874*\hat{ }-13 joules or 642.089 Kev at a 0.87×10\hat{ }-15 radius in meters. These can be produced in a bulk process given enough constituent quarks to be confined into the quantum substrates. The ratio of quarks must be maintained to successfully construct the quantum substrates however being the ratio of one Top quark, one anti-Top quark, two up quarks, and one down quark in bulk synthesis being a 1:1:2:1 ratio.

The exact synthesis using synthetic particle confinement synthesis for the Neutronium Quantum Substrate follows a similar pattern to the “Red Matter” Quantum Substrate which first you must use a super collider to obtain the anti-protons used in the quantum substrate along with a source of solitary neutrons and protons. The constituent particles would be laser heated and accelerated to near the speed of light entering the magnetic confinement within the torodial chamber. Next, the particles would be magnetically confined at a binding energy similar to helium 5's binding energy which is 28 Mev with a energy density of 1.09523925781*10\hat{ }33 J/m\hat{ }3 which will form a quantum substrate with a rest mass of 5.5 Gev being the Neutronium Quantum Substrate. The particle in a box values of this Quantum Substrate are similar to helium 5's particle in a box values which are well known. The Neutronium Quantum Substrate has a neutral charge of zero thus it will immediately break confinement by the magnetic field when synthesized, however it should be stable unlike helium 5 as the electromagnetic repulsion should be minimal based on its structure of a proton and anti-proton along with three neutrons. For bulk synthesis the ratio of anti-protons, protons, and neutrons must be maintained in a 1:1:3 ratio which it should be possible to synthesize as much as you wanted given enough constituent particles in a plasma state.

The anti-matter versions of the quantum substrate particles use the same configurations of quarks and hadrons however with the opposite charge of each quantum substrate particle. The anti-quarks will also have the opposite charge that are used in the synthesis of the quantum substrate which will make the anti-matter version of the quantum substrate if the anti-matter quarks are used. There is currently no known asymmetry between matter and anti-matter thus the anti-matter quantum substrates should have the exact same rest mass as their matter counterparts. The synthesis is exactly the same just the only difference is the anti-matter quarks and hadrons are used for the anti-matter quantum substrates.

### How to Use

The Synthetic particle confinement synthesis for various particles was well defined in previous explanations however taking the constituent quarks and particles then forming them into a quantum substrate particle via magnetic confinement under proper energy conditions.

The “Red Matter” Quantum Substrate can be used as a efficient fuel for antimatter powered spacecraft much like antimatter but with much higher rest mass of 344 Gev than anti-protons being 937 Mev and positrons 511 Kev. The “Red Matter” Quantum substrate also instantly destabilizes outside a magnetic confinement field into energy thus making it perfect for energy storage and usage being most likely gamma radiation of high energies much like anti-matter particles.

The Neutronium Quantum Substrate has a weak electromagnetic field due to have balanced charged and a net zero charge tightly packed together. This may be what neutron star matter is like to a extent it could be used a wonderful building material for Dyson spheres and spacecraft once constructed in bulk as sort of stable alternative to using neutron star neutronium which is pure neutrons with a half life of around 30 minutes outside a neutron star also requiring very high pressures to keep stable. This Neutronium Quantum Substrate could be a stable version of neutron star matter if not then it could be used as a energy source for spacecraft as well.

1. The synthesis of any man made particle by the method of Synthetic Particle Confinement Synthesis especially the synthesis of Neutronium Quantum Substrates and “Red Matter” Quantum Substrates.

2. The Synthesis of Neutronium Quantum Substrates which are constructed of a Proton and Anti-Proton along with three Neutrons being a charge of 0 along with the anti-matter version of the quarks being the anti-matter version of the particle.

3. The Synthesis of “Red Matter” Quantum Substrates which are constructed of a Top quark and anti-Top quark along with two Up quarks and a Down quark being a charge of +1 or −1 being the matter or anti-matter version of the quarks with opposite charge in the anti-matter version of the particle.
